(19) United States
(12) Patent Application Publication
(10) Pub. No.: US 2025/0129232 A1
(43) Pub. Date: Apr. 24, 2025

(54) RESIN COMPOSITION FOR LASER WELDING, COMPOSITE MOLDED BODY, AND METHOD FOR IMPROVING LASER BEAM TRANSMITTANCE OF RESIN COMPOSITION

(71) Applicant: Polyplastics Co., Ltd., Tokyo (JP)

(72) Inventor: Yunosuke Tsuboi, Fuji-shi, Shizuoka (JP)

(73) Assignee: Polyplastics Co., Ltd., Tokyo (JP)

(21) Appl. No.: 18/834,325

(22) PCT Filed: Jan. 25, 2023
(86) PCT No.: PCT/JP2023/002188

§ 371 Date: Jul. 30, 2024

(30) Foreign Application Priority Data
Jan. 31, 2022 (JP) 2022-013687

(51) Int. Cl. C08K 3/013; B23K 26/70; B23K 103/16; B29C 48/68; B29K 81/00; B29K 505/00; B29K 509/08; C08K 5/098; C08K 7/14

(52) U.S. Cl. CPC C08K 3/013; B23K 26/702; B29C 48/68; C08K 5/098; C08K 7/14; B23K 2103/16; B29K 2081/04; B29K 2505/00; B29K 2509/08; C08K 2201/004; C08K 2201/005

(57) ABSTRACT

A polyarylene sulfide resin composition that is suitable for laser welding, and a method for producing the same are provided. A method for improving the laser beam transmittance of a molded body containing a polyarylene sulfide resin is also provided. The resin composition for laser welding contains: 100 parts by mass of a polyarylene sulfide resin; and at least 0.03 parts by mass and at most 1.05 parts by mass of a laser beam transmittance improving agent including at least one material selected from the group consisting of potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic.

### TECHNICAL FIELD

The present invention relates to a resin composition for laser welding, a composite molded body, and a method for improving the laser beam transmittance of a resin composition.

### BACKGROUND

As a technology for joining resin molded bodies to each other, laser welding is known. In laser welding, a transmission-side molded body that transmits a laser beam emitted from a light source and an absorption-side molded body that absorbs the laser beam are stacked so that the surfaces to be joined are in contact with each other, and a laser beam is radiated from the transmission-side molded body towards the absorption-side molded body. By being irradiated with the laser beam, the stacked interface is heated, melted, and joined. For this reason, the laser beam transmittance of the resin composition used in the transmission-side molded body is preferably as high as possible.

Polyarylene sulfide resins have excellent heat resistance, mechanical properties, chemical resistance, dimensional stability, and flame retardance, and are therefore widely used as electric/electronic equipment component materials, automotive component materials, chemical equipment component materials, etc. However, polyarylene sulfide resins have high optical refractive indices and therefore have low laser beam transmittance relative to other resins. Additionally, polyarylene sulfide resins have a large difference in optical refractive index with respect to inorganic fillers (e.g., glass fibers). Therefore, the transmittance is further reduced in resin composition molded bodies containing inorganic fillers.

Patent Document 1 describes that a transmissive material comprising a resin molded member that transmits laser beams comprises a polyphenylene sulfide resin having a prescribed weight-average molecular weight. Patent Document 2 describes a polyphenylene sulfide resin composition for laser welding, wherein the cooling crystallization temperature is within a prescribed range.

Meanwhile, Patent Document 3 describes a heat aging-resistant resin composition containing a polyarylene sulfide resin and an anti-heat aging agent.
Patent Document 1: JP 2006-168221 A
Patent Document 2: JP 2005-15792 A
Patent Document 3: JP 2014-210914 A

### SUMMARY OF INVENTION

A first problem addressed by the present invention is to provide a polyarylene sulfide resin composition that is suitable for laser welding, and a method for production thereof.

A second problem addressed by the present invention is to provide a method for improving the laser beam transmittance of a molded body containing a polyarylene sulfide resin.

In Patent Documents 1 and 2, a high-molecular-weight polyarylene sulfide resin is used to increase the joining strength due to laser welding. Unlike such conventional methods, the present inventors carried out diligent research into methods for increasing laser beam transmittance by making improvements to the additives to the resin composition. As a result thereof, they discovered, surprisingly, that certain compounds such as zinc hydroxide have the function of improving the laser beam transmittance regardless of the magnitude of the molecular weight of the polyarylene sulfide resin, thereby completing the present invention.

The present invention has the embodiments indicated below.

[1]A resin composition for laser welding, comprising: 100 parts by mass of a polyarylene sulfide resin; and at least 0.03 parts by mass and at most 1.05 parts by mass of a laser beam transmittance improving agent comprising at least one material selected from the group consisting of potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic.
[2] The resin composition according to [1], comprising more than 0 and at most 105 parts by mass of an inorganic filler relative to 100 parts by mass of the polyarylene sulfide resin.
[3] The resin composition according to [2], wherein the inorganic filler comprises a fibrous inorganic filler having a cross-sectional area, perpendicular to a lengthwise direction, of at least 60 μm² and at most 500 μm².
[4] The resin composition according to [2] or [3], wherein the inorganic filler comprises a particulate inorganic filler having an average particle size of at least 10 μm and at most 40 μm.
[5] The resin composition according to any one of [1] to [4], comprising at least 0.1 parts by mass and at most 1.5 parts by mass of an alkoxysilane compound relative to 100 parts by mass of the polyarylene sulfide resin.
[6] The resin composition according to any one of [1] to [5], wherein the polyarylene sulfide resin has a weight-average molecular weight of at least 10,000 and at most 80,000.
[7] The resin composition according to any one of [1] to [6], used to produce a laser beam transmission-side molded body.
[8]A laser beam transmission-side molded body comprising the resin composition according to any one of [1] to [7].
[9]A composite molded body comprising a laser beam transmission-side molded body comprising the resin composition according to any one of [1] to [7], and a laser beam absorption-side molded body.
[10]A method for producing a resin composition for laser welding, the method comprising:
melt-kneading 100 parts by mass of a polyarylene sulfide resin with at least 0.03 parts by mass and at most 1.05 parts by mass of a laser beam transmittance improving agent comprising at least one material selected from the group consisting of potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic.
   [11] The method according to [10], wherein the melt-kneading is performed with a cylinder temperature of a kneading portion in an extruder set to be at least 160° C. and at most 370° C.
   [12]A method for improving laser beam transmittance of a molded body comprising a polyarylene sulfide resin composition, the method comprising: blending, with respect to 100 parts by mass of the polyarylene sulfide resin, at least 0.03 parts by mass and at most 1.05 parts by mass of at least one material selected from the group consisting of potassium hydroxide, sodium hydroxide, lithium acetate, sodium acetate, calcium hydroxide, potassium acetate, lithium hydroxide, zinc hydroxide, zinc acetate, magnesium hydroxide, zinc oxide, zinc carbonate, and zinc carbonate basic.
   [13] The method according to [12], wherein the polyarylene sulfide resin composition comprises more than 0 and at most 105 parts by mass of an inorganic filler relative to 100 parts by mass of the polyarylene sulfide resin.
   [14] The method according to [13], wherein the inorganic filler comprises a fibrous inorganic filler having a cross-sectional area, perpendicular to a lengthwise direction, of at least 60 μm² and at most 500 μm².
   [15] The method according to [13] or [14], wherein the inorganic filler comprises a particulate inorganic filler having an average particle size of at least 10 μm and at most 40 μm.
   [16] The method according to any one of [12] to [15], comprising at least 0.1 parts by mass and at most 1.5 parts by mass of an alkoxysilane compound relative to 100 parts by mass of the polyarylene sulfide resin.
   [17] The method according to any one of [12] to [16], wherein the weight-average molecular weight of the polyarylene sulfide resin is at least 10,000 and at most 80,000.

According to the present invention, a polyarylene sulfide resin composition that is suitable for laser welding, and a method for producing the same can be provided. According to the present invention, a method for improving the laser beam transmittance of a molded body containing a polyarylene sulfide resin can be provided.

### BRIEF DESCRIPTION OF DRAWINGS

FIG. 1 is a schematic explanatory diagram regarding test pieces used to measure laser beam transmittance in examples and comparative examples.

### DESCRIPTION OF EMBODIMENTS

Hereinafter, an embodiment of the present invention will be explained in detail. The present invention is not limited to the embodiment below, and can be implemented by introducing changes, as appropriate, within a range not hindering the effects of the present invention. In cases in which a specific explanation describing an embodiment also applies to another embodiment, the explanation may sometimes be omitted for the other embodiment. In the present specification, the expression “X−Y” means “at least X and at most Y”.

### [Resin Composition for Laser Welding]

The resin composition for laser welding according to the present embodiment (hereinafter also referred to simply as the “resin composition”) contains a polyarylene sulfide resin and a laser beam transmittance improving agent.

### (Polyarylene Sulfide Resin)

The polyarylene sulfide resin is a resin having repeat units indicated by general formula (I) below:

—(Ar—S)— (1)

(where Ar denotes an arylene group).

The arylene group is not particularly limited, but for example, may be a p-phenylene group, an m-phenylene group, an o-phenylene group, a substituted phenylene group, a p,p′-diphenylene sulfone group, a p,p′-biphenylene group, a p,p′-diphenylene ether group, a p,p′-diphenylene carbonyl group, a naphthalene group, etc. The polyarylene sulfide resin may be a homopolymer in which the same repeat units are used among the repeat units indicated by general formula (I) above, or may be a copolymer including repeat units of different types.

As homopolymers, those having p-phenylene groups as the arylene groups and having p-phenylene sulfide groups as the repeat units are preferable. This is because homopolymers having p-phenylene sulfide groups as repeat units have extremely high heat resistance, have high strength and high rigidity over a wide temperature range, and furthermore, exhibit high dimensional stability. By using such homopolymers, molded bodies provided with extremely exceptional physical properties can be obtained.

As copolymers, combinations of two or more different types of arylene sulfide groups among arylene sulfide groups including the above-described arylene groups may be used. Among these, combinations including p-phenylene sulfide groups and m-phenylene sulfide groups are preferable from the aspect of obtaining molded bodies provided with superior physical properties such as heat resistance, moldability, and mechanical properties. Polymers containing at least 70 mol % of p-phenylene sulfide groups are more preferable, and polymers containing at least 80 mol % are even more preferable. Polyarylene sulfide resins having phenylene sulfide groups are polyphenylene sulfide resins (PPS resins).

As polyarylene sulfide resins, in general, in accordance with the production methods thereof, those having a molecular structure that is substantially linear and lacking branched or crosslinked structures, and those having a structure having branches and crosslinks are known. In one embodiment, it is more preferable to not include structures having crosslinked structures from the aspect of improving the laser beam transmittance.

The resin composition according to the present embodiment can increase the laser beam transmittance of a molded body regardless of the magnitude of the molecular weight of the polyarylene sulfide resin.

In one embodiment, the weight-average molecular weight (Mw) of the polyarylene sulfide resin is preferably at least 10,000 and at most 80,000, and more preferably at least 30,000 and at most 80,000.

In one embodiment, the weight-average molecular weight (Mw) of the polyarylene sulfide resin may be at least 10,000 and lower than 40,000, or may be at least 20,000 and at most 38,000. Even in the case in which a low-molecular-weight polyarylene sulfide resin having a weight-average molecular weight (Mw) of at least 10,000 and lower than 40,000 is used, the laser beam transmittance can be increased and a polyarylene sulfide resin composition that is suitable for laser welding can be obtained.

In one embodiment, the weight-average molecular weight (Mw) of the polyarylene sulfide resin may be at least 40,000 and at most 80,000, or may be at least 50,000 and at most 80,000.

In one embodiment, the weight-average molecular weight (Mw) of the polyarylene sulfide resin may be at least 70,000 and at most 80,000. Even in the case in which a high-molecular-weight polyarylene sulfide resin having a weight-average molecular weight (Mw) of at least 70,000 is used, the laser beam transmittance can be increased and a polyarylene sulfide resin composition that is suitable for laser welding can be obtained.

As the polyarylene sulfide resin used in the present embodiment, polyarylene sulfide resins having two or more different weight-average molecular weights (Mw) may be mixed and used. The weight-average molecular weight (Mw) of a polyarylene sulfide resin in the case in which two or more types are mixed is the weight-average molecular weight (Mw) of the polyarylene sulfide resin after being mixed.

The weight-average molecular weight (Mw) can be measured as follows. That is, 1-chloronaphthalene is used as a solvent, heated and dissolved in an oil bath at 230° C./10 min, and purified by high-temperature filtration as necessary, thereby preparing a solution with a concentration of 0.05 mass %. High-temperature gel-permeation chromatography is performed to calculate the weight average molecular weight in terms of standard polystyrene. As a measuring apparatus, for example, a UV detector (detection wavelength: 360 nm), having the product name “SSC-7000” manufactured by Senshu Scientifico co., ltd., is used.

The method for producing the polyarylene sulfide resin is not particularly limited, and a conventionally known production method can be used. In the case in which a high-molecular-weight polyarylene sulfide resin is to be obtained, for example, it can be produced by synthesizing a low-molecular-weight polyarylene sulfide resin, then polymerizing the resin at a high temperature in the presence of a known polymerization aid to obtain a high molecular weight.

In one embodiment, the polyarylene sulfide resin content in the resin composition is preferably at least 45 mass % and more preferably at least 50 mass %.

In one embodiment, polyarylene sulfide resins may constitute preferably at least 80 mass % and more preferably at least 90 mass % of thermoplastic resins contained in the resin composition. In one embodiment, the thermoplastic resins contained in the resin composition may be constituted only by polyarylene sulfide resins.

### (Laser Beam Transmittance Improving Agent)

The “laser beam transmittance improving agent” in the present embodiment refers to an agent having the function of increasing the laser beam transmittance in comparison with a molded body composed of a resin composition not containing a laser beam transmittance improving agent. The “laser beam transmittance” is the laser beam transmittance at a wavelength of 800-1000 nm with an optical path length of 1.0 mm. In one embodiment, the laser beam transmittance may be the laser beam transmittance at a wavelength of 980 nm with an optical path length of 1.0 mm. The laser beam transmittance is measured by using a spectrophotometer.

The laser beam transmittance improving agent contains at least one material selected from the group consisting of potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic. By including a laser beam transmittance improving agent, the laser beam transmittance of molded bodies can be increased. As a result thereof, a polyarylene sulfide resin composition suitable for laser welding can be obtained.

The laser beam transmittance improving agent preferably contains at last one material selected from the group consisting of sodium acetate, lithium acetate, zinc hydroxide, zinc oxide, zinc carbonate, and zinc carbonate basic; more preferably contains at least one material selected from the group consisting of sodium acetate, lithium acetate, zinc hydroxide, zinc carbonate, and zinc carbonate basic; even more preferably contains at least one material selected from the group consisting of sodium acetate, lithium acetate, zinc hydroxide, and zinc carbonate; and particularly preferably contains at least one material selected from the group consisting of zinc hydroxide and zinc carbonate. In one embodiment, the laser beam transmittance improving agent may be constituted only by at least one material selected from the group consisting of sodium acetate, lithium acetate, zinc hydroxide, zinc carbonate, and zinc carbonate basic; may be constituted only by at least one material selected from the group consisting of sodium acetate, lithium acetate, zinc hydroxide, and zinc carbonate; or may be constituted only by at least one material selected from the group consisting of zinc hydroxide and zinc carbonate.

Patent Document 3 proposes that potassium hydroxide, sodium hydroxide, sodium acetate, calcium hydroxide, potassium acetate, lithium hydroxide, zinc hydroxide, zinc acetate, magnesium hydroxide, zinc oxide, zinc carbonate, and zinc carbonate basic, even when a molded body undergoes long-term heating (heat aging), have the capability (heat aging prevention capability) to suppress decreases in tensile strength, tensile elongation and resistivity, to suppress increases in dielectric constant, to suppress coloration, to suppress gas generation, etc. However, the laser beam transmittance is not considered.

In one embodiment, the laser beam transmittance improving agent has the function of improving the laser beam transmittance of a molded body after being molded and before undergoing heat treatment (heat aging).

The laser beam transmittance improving agent content is at least 0.03 parts by mass and at most 1.05 parts by mass, preferably at least 0.04 parts by mass and at most 1.00 parts by mass, more preferably at least 0.05 parts by mass and at most 0.90 parts by mass, even more preferably at least 0.06 parts by mass and at most 0.80 parts by mass, and particularly preferably at least 0.07 parts by mass and at most 0.70 parts by mass relative to 100 parts by mass of the polyarylene sulfide resin. By setting the laser beam transmittance improving agent content to be at least 0.03 parts by mass and at most 1.05 parts by mass relative to 100 parts by mass of the polyarylene sulfide resin, the laser beam transmittance of molded bodies can be increased, and a polyarylene sulfide resin composition suitable for laser welding can be obtained.

### (Inorganic Filler)

The resin composition may include an inorganic filler, as needed, from the aspect of improving the mechanical strength. As described above, polyarylene sulfide resins have an optical refractive index that differs significantly from that of inorganic fillers (e.g., glass fibers), and therefore, the transmittance tends to become even lower in resin composition molded bodies containing inorganic fillers. However, according to the resin composition of the present embodiment, even in the case in which an inorganic filler is included, the laser beam transmittance of molded bodies can be improved, and a polyarylene sulfide resin composition that is suitable for laser welding can be obtained.

The shape of the inorganic filler is not limited, and one or more types selected from among fibrous inorganic fillers, flake-shaped inorganic fillers, and particulate inorganic fillers can be included. From the aspect of improving the laser beam transmittance, one of or a combination of both a fibrous inorganic filler and a particulate inorganic filler is more preferably used. As the inorganic filler, one type may be used alone, or a combination of two or more types may be used.

In the present embodiment, the term “fibrous” refers to a shape for which the different diameter ratio is 1 to 4, and for which the average fiber length (cut length) is 0.01-3 mm. The term “flake-shaped” refers to a shape for which the different diameter ratio is larger than 4, and for which the aspect ratio is 1-500. The term “particulate” refers to a shape (including spherical) for which the different diameter ratio is 1 to 4, and for which the aspect ratio is 1 to 2. All of the shapes are initial shapes (shapes before melt-kneading). The different diameter ratio is defined as “long diameter of cross-section perpendicular to lengthwise direction (longest straight-line distance in the cross-section)/short diameter of said cross-section (longest straight-line distance in direction perpendicular to long diameter)”. The aspect ratio is defined as “longest straight-line distance in lengthwise direction/short diameter of cross-section perpendicular to lengthwise direction (longest straight-line distance in direction perpendicular to straight line with longest distance in said cross-section)”. The different diameter ratio and the aspect ratio can both be calculated by using a scanning electron microscope and image processing software. Additionally, as the average fiber length (cut length), manufacturer values (numerical values announced by manufacturers in catalogs, etc.) can be employed.

The inorganic filler is preferably a transparent inorganic filler from the aspect of further increasing the laser beam transmittance. Transparent fibrous inorganic fillers include glass fibers, etc., transparent flake-shaped inorganic fillers include glass flakes, etc., and transparent particulate inorganic fillers include particulate glass (glass beads, glass powders, etc.). Among these, glass fibers and/or glass beads are preferably included, and glass beads are more preferably included.

As the fibrous inorganic filler, a fibrous inorganic filler for which the cross-sectional shape perpendicular to the lengthwise direction is circular, substantially circular, oval, elliptical, semicircular, cocoon-shaped, rectangular or a similar shape can be used, and milled fibers obtained by pulverizing a fibrous inorganic filler can also be used. The cross-sectional shape perpendicular to the lengthwise direction is, particularly preferably, circular, substantially circular, oval, or elliptical. The term “cocoon-shaped” refers to a shape in which the area near the center, in the lengthwise direction, of an oval is inwardly indented.

The fibrous inorganic filler, from the aspect of further increasing the mechanical properties, has a cross-sectional area perpendicular to the lengthwise direction, in terms of the initial shape (the shape before melt-kneading), of preferably at least 15 μm² and at most 2000 μm², more preferably at least 60 μm² and at most 500 μm², and even more preferably at least 75 μm² and at most 300 μm². The expression “cross-sectional area perpendicular to the lengthwise direction” refers to the area of a surface perpendicular to the lengthwise direction in a fibrous inorganic filler. The “cross-sectional area” can be measured by using a scanning electron microscope and image processing software. In the case in which the cross-sectional shape perpendicular to the lengthwise direction is circular, substantially circular, oval, or elliptical, when the longest straight-line distance in the cross-section of a fibrous inorganic filler measured by using a scanning electron microscope and image processing software is defined as the long diameter and the shortest straight-line distance is defined as the short diameter, the cross-sectional area can be defined as the value obtained by multiplying the value of the long diameter divided by 2 with the value of the short diameter divided by 2, then further multiplying pi (π) thereto.

Although the average fiber length of the fibrous inorganic filler is not particularly limited, considering the mechanical properties, the mold workability, etc. of the molded bodies, the average fiber length (cut length) in the initial shape is preferably 0.01-3 mm, more preferably 0.05-3 mm, even more preferably 0.1-3 mm, and particularly preferably 0.5-3 mm. It is also possible to use hollow fibers as the fibrous inorganic filler for the purpose of lightening the specific gravity of the resin composition, etc. The average fiber lengths are as described above.

The average particle size (volume-based cumulative 50% diameter D₅₀) of the flake-shaped inorganic filler, in the initial shape (the shape before melt-kneading), is preferably at least 10 μm and at most 1000 μm, and more preferably at least 30 μm and at most 800 μm. The average particle size (volume-based cumulative 50% diameter D₅₀) can be measured by the laser diffraction scattering method.

The average particle size (volume-based cumulative 50% diameter D₅₀) of the particulate filler, in the initial shape (the shape before melt-kneading), is preferably at least 0.1 μm and at most 50 μm, more preferably at least 1 μm and at most 45 μm, and even more preferably at least 10 μm and at most 40 μm. The average particle size (volume-based cumulative 50% diameter D₅₀) can be measured by the laser diffraction scattering method.

Glass beads have a large surface area and therefore largely scatter laser beams. Thus, the transmittance improvement effects were expected to be low. However, contrary to expectations, results with high transmittance improvement effects were obtained even with resin compositions containing glass beads.

The inorganic filler content is preferably more than 0 and at most 105 parts by mass, more preferably at least 5 parts by mass and at most 100 parts by mass, even more preferably at least 10 parts by mass and at most 95 parts by mass, yet more preferably at least 15 parts by mass and at most 90 parts by mass, and particularly preferably at least 20 parts by mass and at most 85 parts by mass relative to 100 parts by mass of the polyarylene sulfide resin.

If the inorganic filler content is more than 0 and at most 105 parts by mass relative to 100 parts by mass of the polyarylene sulfide resin, the mechanical strength can be further increased while maintaining the laser beam transmittance improvement effect.

### (Alkoxysilane Compound)

The resin composition preferably contains an alkoxysilane compound. By containing an alkoxysilane compound, the laser beam transmittance of molded bodies can be further improved, and a polyarylene sulfide resin composition that is more suitable for laser welding can be obtained.

The alkoxysilane compound is not particularly limited, and for example, may be an alkoxysilane such as an epoxyalkoxysilane, an aminoalkoxysilane, a vinylalkoxysilane, a mercaptoalkoxysilane, etc., among which one or two types are preferably used. The alkoxy groups preferably have 1-10, particularly preferably 1-4 carbon atoms.

Examples of epoxyalkoxysilanes include γ-glycidoxypropyl trimethoxysilane, β3-(3,4-epoxycyclohexyl)ethyl trimethoxysilane, γ-glycidoxypropyl triethoxysilane, etc.

Examples of aminoalkoxysilanes include γ-aminopropyl trimethoxysilane, γ-aminopropyl triethoxysilane, γ-aminopropylmethyl dimethoxysilane, γ-aminopropylmethyl diethoxysilane, N-(β-aminoethyl)-γ-aminopropyl trimethoxysilane, N-phenyl-γ-aminopropyl trimethoxysilane, γ-diallylaminopropyl trimethoxysilane, γ-diallylaminopropyl triethoxysilane, etc.

Examples of vinylalkoxysilanes include vinyl trimethoxysilane, vinyl triethoxysilane, vinyl tris(β-methoxyethoxy)silane, etc.

Examples of mercaptoalkoxysilanes include γ-mercaptopropyl trimethoxysilane, γ-mercaptopropyl triethoxysilane, etc.

Among the above, epoxyalkoxysilanes and aminoalkoxysilanes are preferable, and γ-aminopropyl triethoxysilane is particularly preferable.

The alkoxysilane compound content is preferably at least 0.1 parts by mass and at most 1.5 parts by mass, more preferably at least 0.1 parts by mass and at most 1.3 parts by mass, even more preferably at least 0.2 parts by mass and at most 1.0 parts by mass, and yet more preferably at least 0.2 parts by mass and at most 0.9 parts by mass relative to 100 parts by mass of the polyarylene sulfide resin. By setting the alkoxysilane compound content to be at least 0.1 parts by mass and at most 1.5 parts by mass relative to 100 parts by mass of the polyarylene sulfide resin, the laser beam transmittance of molded bodies can be further improved.

### (Other Additives)

The resin composition may contain, as needed, within a range not hindering the effects of the present invention, a lubricant, a nucleating agent, a flame retardant, a flame retardance promoter, an antioxidant, a metal deactivator, a UV absorber, a stabilizer, a plasticizer, a pigment, a dye, a colorant, an antistatic agent, a foaming agent, a polymer such as another resin, or an additive.

In one embodiment, from the aspect of further increasing the laser beam transmittance improvement effects, the carbon black content in the resin composition is preferably lower than 0.01 mass %, and more preferably 0%. In one embodiment, the pigment content in the resin composition is preferably lower than 0.02 mass %. In one embodiment, the dye content in the resin composition is preferably lower than 2 mass %, and more preferably lower than 1 mass %.

### (Utility)

The resin composition according to the present embodiment contains a polyarylene sulfide resin, and therefore has excellent heat resistance, mechanical properties, etc. Thus, it can be widely used as an electric/electronic equipment component material, an automotive component material, a chemical equipment component material, etc. In particular, it can increase the laser beam transmittance of molded bodies, and can thus be favorably used as a resin composition for laser welding in order to produce molded bodies for laser welding. In particular, it is suitable for producing laser beam transmission-side molded bodies.

### [Resin Composition Production Method]

The method for producing a resin composition for laser welding according to the present embodiment involves melt-kneading 100 parts by mass of a polyarylene sulfide resin with at least 0.03 parts by mass and at most 1.05 parts by mass of a laser beam transmittance improving agent comprising at least one material selected from the group consisting of potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic.

The polyarylene sulfide resin and the laser transmittance improving agent are as described above.

The melt-kneading can be performed by a method and with equipment generally used to prepare resin compositions. In general, the necessary components are mixed and are melt-kneaded by using a single-screw or twin-screw extruder. Then, the resin composition can be extruded to form pellets for molding.

Generally, a cylinder of an extruder is provided with a screw, this screw having a supply portion, a plasticizing portion, and a kneading portion in the direction from the upstream side to the downstream side. Additionally, a hopper for supplying raw materials is provided at the upstream end of the cylinder, and a die is connected to the downstream end.

The supply portion has the function of conveying a raw material that has been supplied inside the cylinder in the extrusion direction (downstream direction). Specifically, conveying screw elements composed of forward flights are used, the screws being turned to convey the raw material in the extrusion direction.

The plasticizing portion has the function of applying shear forces to the raw material and generating heat, thereby sufficiently melting the raw material. In the plasticizing portion, screw elements having a plasticizing capability (the capability to melt the resin) are used.

The kneading portion has the function of sufficiently kneading the raw material in the melted state, thereby more evenly mixing the raw material. In the kneading portion, as in the plasticizing portion, screw elements that can apply compressive stress, shear stress, etc. to the raw materials in the melted state can be used. Additionally, normally, a plasticizing portion and a kneading portion are arranged in a row with conveying screw elements interposed therebetween. Thus, the plasticizing portion and the kneading portion can be clearly distinguished.

In one embodiment, the method for producing the resin composition includes melt-kneading with the cylinder temperature of the kneading portion in the extruder set preferably to at least 160° C. and at most 370° C., and more preferably to at least 200° C. and at most 360° C. The cylinder temperature of the plasticizing portion is preferably at least 300° C. and at most 370° C.

Conventionally, the lower the cylinder temperature of the kneading portion is at the time of melt-kneading, the higher the laser beam transmittance tends to be. However, according to the resin composition in the present embodiment, even if the cylinder temperature of the kneading portion at the time of melt-kneading is high, the effect of improving the laser beam transmittance of molded bodies can be obtained. In one embodiment, the cylinder temperature of the kneading portion at the time of melt-kneading may be set to be at least 320° C. and at most 360° C., or may be set to be higher than 320° C. and at most 360° C.

### [Molded Body]

The molded body according to the present embodiment is a laser beam transmission-side molded body (hereinafter also referred to simply as “molded body”) containing the resin composition described above. Since it contains the above-described resin composition, the molded body can be made suitable for laser welding.

The molded body can be produced by molding moldable pellets containing the above-described resin composition by using a generally known thermoplastic resin molding method such as injection molding, extrusion molding, vacuum forming, compression molding, etc.

The temperature at the time of molding, from the aspect of further increasing the laser beam transmittance, is preferably 300-360° C., and more preferably 300-320° C.

In the molded body, the laser beam transmittance at a wavelength of 800-1000 nm for an optical path length of 1.0 mm is higher than that of a polyarylene sulfide resin not containing a laser beam transmittance improving agent.

The laser beam transmittance is the laser beam transmittance at a wavelength of 800-1000 nm for an optical path length of 1.0 mm. In one embodiment, the laser beam transmittance may be the laser beam transmittance at a wavelength of 980 nm for an optical path length of 1.0 mm. In one embodiment, the laser beam transmittance can be measured as the transmittance when a molded body with dimensions of length 80 mm×width 80 mm×thickness 1.0 mm (film gate, gate width 80 mm), formed by injection molding, is irradiated with a laser beam (wavelength 800-1000 nm, preferably 980 nm) perpendicularly from a main surface on one side to a main surface on the opposite side. The laser beam transmittance is measured by using a spectrophotometer.

In one embodiment, the ratio (T1/T2) between the laser transmittance (T1) of the molded body and the laser transmittance (T2) of a molded body composed of a polyarylene sulfide resin not containing a laser beam transmittance improving agent is at least 1.02 (preferably at least 1.04) near a gate, at least 1.05 (preferably at least 1.08) near the center of the molded body, and at least 1.02 (preferably at least 1.04) on a flowing end side.

The laser beam transmittance is a value measured by using a spectrophotometer.

### [Composite Molded Body]

The composite molded body according to the present embodiment includes a laser beam transmission-side molded body containing the above-described resin composition, and a laser beam absorption-side molded body. The laser beam transmission-side molded body is as described above.

The resin constituting the laser beam absorption-side molded body is not particularly limited as long as it is a resin that can be laser-welded to a polyarylene sulfide resin, and it may be a polyarylene sulfide resin, a resin other than a polyarylene sulfide resin, or a mixture thereof.

The laser beam absorption-side molded body may contain a colorant or an absorber of the laser beam. The colorant may be selected in accordance with the wavelength of the laser beam, and for example, a known inorganic pigment or organic pigment may be used.

The method for producing the composite molded body includes irradiating the laser beam transmission-side molded body and the laser beam absorption-side molded body, in a state in which they are stacked together so that the surfaces to be joined are in contact with each other, with a laser beam from the laser beam absorption-side molded body.

The laser beam source is not particularly restricted, and for example, a dye laser, a gas laser (excimer laser, argon laser, krypton laser, helium-neon laser, etc.), a solid-state laser (YAG laser, etc.), a semiconductor laser, etc. may be used. As the laser beam, a pulsed laser is normally used.

### [Laser Beam Transmittance Improvement Method]

The laser beam transmittance improvement method according to the present embodiment is a method for improving the laser beam transmittance of a molded body containing a polyarylene sulfide resin composition, involving blending, with respect to 100 parts by mass of the polyarylene sulfide resin, at least 0.03 parts by mass and at most 1.05 parts by mass of at least one material selected from the group consisting of potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic. The polyarylene sulfide resin is as described above.

The expression “improving the laser beam transmittance” refers to increasing the laser beam transmittance, in the initial state (in the state before heat treatment, etc.), more than that of a molded article composed of a resin composition not containing potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic. The “laser beam transmittance” is as described above.

As described above, it was discovered that potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic have the function of increasing the laser beam transmittance of molded bodies. The content of the above-described compounds is at least 0.03 parts by mass and at most 1.05 parts by mass, preferably at least 0.04 parts by mass and at most 1.00 parts by mass, more preferably at least 0.05 parts by mass and at most 0.90 parts by mass, even more preferably at least 0.06 parts by mass and at most 0.80 parts by mass, and particularly preferably at least 0.07 parts by mass and at most 0.70 parts by mass, relative to 100 parts by mass of the polyarylene sulfide. By blending at least 0.03 parts by mass and at most 1.05 parts by mass relative to 100 parts by mass of the polyarylene sulfide resin, the laser beam transmittance of molded bodies can be improved.

In the laser beam transmittance improvement method according to the present embodiment, an alkoxysilane compound is preferably further blended. The types of alkoxysilane compounds are as described above.

The alkoxysilane compound content is preferably at least 0.1 parts by mass and at most 1.5 parts by mass, more preferably at least 0.1 parts by mass and at most 1.3 parts by mass, even more preferably at least 0.2 parts by mass and at most 1.0 parts by mass, and yet more preferably at least 0.2 parts by mass and at most 0.9 parts by mass, relative to 100 parts by mass of the polyarylene sulfide resin.

In the laser beam transmittance improvement method according to the present embodiment, the polyarylene sulfide resin composition may contain the above-described inorganic filler. As described above, polyarylene sulfide resins have an optical refractive index that differs significantly from that of inorganic fillers (e.g., glass fibers), and therefore, the transmittance tends to become even lower in resin composition molded bodies containing inorganic fillers. However, according to the laser beam transmittance improvement method of the present embodiment, even in the case in which the polyarylene sulfide resin contains an inorganic filler, the laser beam transmittance of molded bodies can be improved. The types and content of the inorganic filler are as described above.

### EXAMPLES

Hereinafter, the present invention will be explained in further detail by indicating examples. However, the present invention should not be construed as being limited by these examples.

### [Material]

The materials used in the examples and the comparative examples are those indicated below.
PPS-1: Polyphenylene sulfide, manufactured by Kureha Corp., Fortron® KPS, weight-average molecular weight (Mw) 64,000
PPS-2: Polyphenylene sulfide, manufactured by Kureha Corp., Fortron® KPS, weight-average molecular weight (Mw) 35,000
Zinc hydroxide: manufactured by Junsei Chemical Co., Ltd.
Zinc carbonate: manufactured by Seido Chemical Industry Co., Ltd.
Zinc oxide: manufactured by Junsei Chemical Co., Ltd.
Sodium acetate: manufactured by Junsei Chemical Co., Ltd.
Lithium acetate: manufactured by FUJIFILM Wako Pure Chemical Corp.
Glass fiber-1: manufactured by Nippon Electric Glass Co., Ltd., “Chopped Strands ECS03T-747”, substantially circular cross-section, average fiber diameter 13 μm, average fiber length 3 mm, cross-sectional area 133 μm²
Glass fiber-2: manufactured by Nippon Electric Glass Co., Ltd., “Chopped Strands ECS03T-747N”, substantially circular cross-section, average fiber diameter 17 μm, average fiber length 3 mm, cross-sectional area 227 μm²
Glass fiber-3: manufactured by Nippon Electric Glass Co., Ltd., “Chopped Strands ECS03T-747H”, substantially circular cross-section, average fiber diameter 10.5 μm, average fiber length 3 mm, cross-sectional area 87 μm²
Glass beads: manufactured by Potters-Ballotini Co., Ltd., “EGB731A”, average particle size (50% d) 20 μm
Alkoxysilane compound: Shin-etsu Chemical Co., Ltd., “KBE-903P”

### Examples 1-1 to 1-9 and Comparative Examples 1-1 to 1-3

The above-described materials were dry-blended with the compositions and content ratios indicated in Table 1. The blended materials were then introduced to and melt-kneaded in a twin-screw extruder with the cylinder temperature in the kneading portion set to be as described in Table 1, thereby obtaining resin composition pellets.

### Examples 2-1 to 2-3 and Comparative Example 2

The above-described materials were dry-blended with the compositions and content ratios indicated in Table 2. The blended materials were then introduced to (the glass fibers were separately added from a side-feed portion of the extruder) and melt-kneaded in a twin-screw extruder with the cylinder temperature in the kneading portion set to be as described in Table 2, thereby obtaining resin composition pellets.

### Examples 3-1 to 3-6 and Comparative Example 3

The above-described materials were dry-blended with the compositions and content ratios indicated in Table 3. The blended materials were then introduced to (the glass fibers were separately added from a side-feed portion of the extruder) and melt-kneaded in a twin-screw extruder with the cylinder temperature in the kneading portion set to be as described in Table 3, thereby obtaining resin composition pellets.

### Examples 4-1 to 4-7 and Comparative Example 4

The above-described materials were dry-blended with the compositions and content ratios indicated in Table 4. The blended materials were then introduced to (the glass fibers were separately added from a side-feed portion of the extruder) and melt-kneaded in a twin-screw extruder with the cylinder temperature in the kneading portion set to be as described in Table 4, thereby obtaining resin composition pellets.

### Examples 5-1 to 5-5 and Comparative Examples 5-1 to 5-5

The above-described materials were dry-blended with the compositions and content ratios indicated in Table 5. The blended materials were then introduced to (the glass fibers were separately added from a side-feed portion of the extruder) and melt-kneaded in a twin-screw extruder with the cylinder temperature in the kneading portion set to be as described in Table 5, thereby obtaining resin composition pellets.

### [Measurement and Evaluation]

### (Measurement of Laser Beam Transmittance of Molded Body)

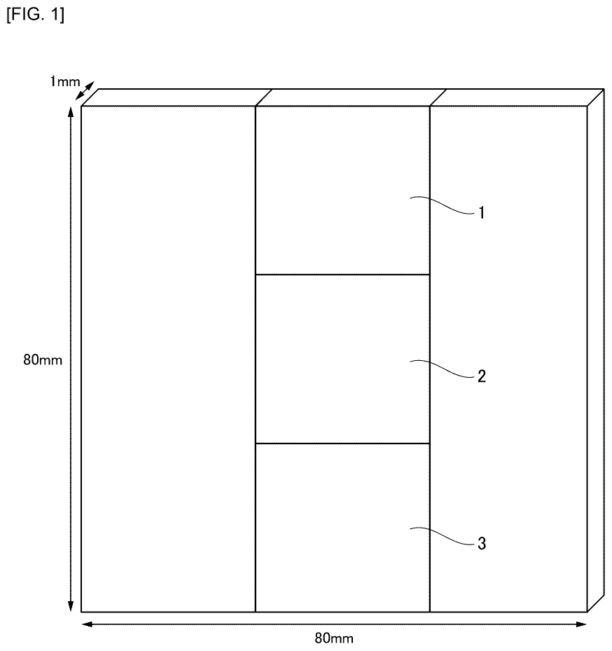

The pellets obtained in the examples and the comparative examples were used to mold molded articles (film gates, length 80 mm×width 80 mm×thickness 1.0 mm) by means of an extrusion molder (manufactured by Fanuc Corp.) under conditions with a cylinder temperature of 320° C. and a die temperature of 150° C. FIG. 1 shows a schematic explanatory diagram for preparing test pieces from the obtained molded articles. In FIG. 1, the upward direction is a gate side and the downward direction is a flow end side. As illustrated in FIG. 1, a molded article is divided in three in the flow direction, and the divided piece at the center is further divided in three in the direction perpendicular to the flow direction. The three divided pieces that have been obtained are defined, in order from the gate side towards the flow end side, as a gate-side test piece 1, a central test piece 2, and a flow end-side test piece 3.

Each test piece was perpendicularly irradiated with a laser beam having a wavelength of 980 nm from one main surface side towards the opposite-side main surface, and the transmittance was measured on the opposite-side main surface side by using a spectrophotometer (manufactured by JASCO Corp., Model V-770) in which an integrating sphere was used. The results are shown in Tables 1 to 5, in which the transmittance of the gate-side test piece 1 is indicated by the “gate-side transmittance”, the transmittance of the central test piece 2 is indicated by the “central transmittance”, and the transmittance of the flow end-side test piece 3 is indicated by the “flow end-side transmittance”.

(Transmittance ratio)

In Table 1, with the respective transmittances of the gate-side test piece 1, the central test piece 2, and the flow end-side test piece 3 of Examples 1-1 to 1-9 indicated by T1, and the respective transmittances of the gate-side test piece 1, the central test piece 2, and the flow end-side test piece 3 of Comparative Example 1 indicated by T2 (reference), a gate-side transmittance ratio (T1/T2), a central transmittance ratio (T1/T2), and a flow end-side transmittance ratio (T1/T2) were calculated.

Similarly, in Tables 2 to 5, the gate-side transmittance ratio (T1/T2), the central transmittance ratio (T1/T2), and the flow end-side transmittance ratio (T1/T2) were calculated. In Tables 2 to 4, the values in Comparative Examples 2 to 4 were used, respectively, as T2. In Table 5, for Example 5-1, the values in Comparative Example 5-1 were used as T2. Similarly, for Examples 5-2 to 5-5, the values in the comparative examples having the same numbers as the examples were used as T2 (i.e., for example, for Example 5-2, the values in Comparative Example 5-2 were used as T2). The results are shown in Tables 1 to 5.

TABLE 1

| | | COMP | COMP. | COMP. | | | | | | | | | |
|---|---|---|---|---|---|---|---|---|---|---|---|---|---|
| | | EX. | EX. | EX. | EX. | EX. | EX. | EX. | EX. | EX. | EX. | EX. | EX. |
| | | 1-1 | 1-2 | 1-3 | 1-1 | 1-2 | 1-3 | 1-4 | 1-5 | 1-6 | 1-7 | 1-8 | 1-9 |
| PPS-1 | PARTS | 100 | 100 | 100 | 100 | 100 | 100 | 100 | 100 | 100 | 100 | 100 | 100 |
| | BY | | | | | | | | | | | | |
| | MASS | | | | | | | | | | | | |
| ZINC | PARTS | — | — | — | 0.20 | 0.50 | 1.01 | — | — | — | — | — | — |
| HYDROXIDE | BY | | | | | | | | | | | | |
| | MASS | | | | | | | | | | | | |
| ZINC | PARTS | — | — | — | — | — | — | 0.20 | 1.01 | — | — | — | — |
| CARBONATE | BY | | | | | | | | | | | | |
| | MASS | | | | | | | | | | | | |
| ZINC OXIDE | PARTS | — | — | — | — | — | — | — | — | 1.01 | — | — | — |
| | BY | | | | | | | | | | | | |
| | MASS | | | | | | | | | | | | |
| SODIUM | PARTS | — | 1.10 | — | — | — | — | — | — | — | 0.20 | — | — |
| ACETATE | BY | | | | | | | | | | | | |
| | MASS | | | | | | | | | | | | |
| LITHIUM | PARTS | — | — | 1.20 | — | — | — | — | — | — | — | 0.20 | 1.01 |
| ACETATE | BY | | | | | | | | | | | | |
| | MASS | | | | | | | | | | | | |
| CYLINDER | ° C. | 320 | 320 | 320 | 320 | 320 | 320 | 320 | 320 | 320 | 320 | 320 | 320 |
| TEMPERATURE | | | | | | | | | | | | | |
| OF KNEADING | | | | | | | | | | | | | |
| PORTION | | | | | | | | | | | | | |
| GATE-SIDE | % | 41.1 | 38.2 | 39.2 | 44.0 | 45.6 | 47.0 | 44.2 | 46.0 | 43.9 | 48.8 | 49.3 | 47.8 |
| TRANSMITTANCE | | | | | | | | | | | | | |
| CENTRAL | % | 41.0 | 38.1 | 39.1 | 43.9 | 45.7 | 47.1 | 44.2 | 46.0 | 43.8 | 49.0 | 49.5 | 48.2 |
| TRANSMITTANCE | | | | | | | | | | | | | |
| FLOW END-SIDE | % | 41.4 | 38.5 | 39.5 | 43.9 | 45.4 | 46.9 | 44.1 | 45.9 | 43.6 | 48.6 | 49.4 | 48.0 |
| TRANSMITTANCE | | | | | | | | | | | | | |
| GATE-SIDE | | REF. | 0.93 | 0.95 | 1.07 | 1.11 | 1.14 | 1.08 | 1.12 | 1.07 | 1.19 | 1.20 | 1.16 |
| TRANSMITTANCE | | | | | | | | | | | | | |
| RATIO (T1/T2) | | | | | | | | | | | | | |
| CENTRAL | | REF. | 0.93 | 0.95 | 1.07 | 1.11 | 1.15 | 1.08 | 1.12 | 1.07 | 1.19 | 1.21 | 1.18 |
| TRANSMITTANCE | | | | | | | | | | | | | |
| RATIO (T1/T2) | | | | | | | | | | | | | |
| FLOW END-SIDE | | REF. | 0.93 | 0.95 | 1.06 | 1.10 | 1.13 | 1.06 | 1.11 | 1.05 | 1.17 | 1.19 | 1.16 |
| TRANSMITTANCE | | | | | | | | | | | | | |
| RATIO (T1/T2) | | | | | | | | | | | | | |

TABLE 2

| | | COMP. | | | |
|---|---|---|---|---|---|
| | | EX. 2 | EX. 2-1 | EX. 2-2 | EX. 2-3 |
| PPS-1 | PARTS BY | 100 | 100 | 100 | 100 |
| | MASS | | | | |
| GLASS FIBER-1 | PARTS BY | 67 | 67 | 67 | 67 |
| | MASS | | | | |
| ZINC HYDROXIDE | PARTS BY | — | 0.08 | 0.17 | 0.50 |
| | MASS | | | | |
| CYLINDER TEMPERATURE OF KNEADING PORTION | ° C. | 360 | 360 | 360 | 360 |
| GATE-SIDE TRANSMITTANCE | % | 23.8 | 25.6 | 26.4 | 26.4 |
| CENTRAL TRANSMITTANCE | % | 26.5 | 29.1 | 30.0 | 29.5 |
| FLOW END-SIDE TRANSMITTANCE | % | 30.3 | 31.5 | 32.9 | 32.2 |
| GATE-SIDE TRANSMITTANCE RATIO (T1/T2) | | REF. | 1.07 | 1.11 | 1.11 |
| CENTRAL TRANSMITTANCE RATIO (T1/T2) | | REF. | 1.10 | 1.13 | 1.11 |
| FLOW END-SIDE TRANSMITTANCE RATIO (T1/T2) | | REF. | 1.04 | 1.09 | 1.06 |

TABLE 3

| | | COMP. | | | | | | |
|---|---|---|---|---|---|---|---|---|
| | | EX. | EX. | EX. | EX. | EX. | EX. | EX. |
| | | 3 | 3-1 | 3-2 | 3-3 | 3-4 | 3-5 | 3-6 |
| PPS-1 | PARTS BY | 100 | 100 | 100 | 100 | 100 | 100 | 100 |
| | MASS | | | | | | | |
| GLASS FIBER-2 | PARTS BY | 43 | 43 | 43 | 43 | 43 | 43 | 43 |
| | MASS | | | | | | | |
| ZINC HYDROXIDE | PARTS BY | — | 0.14 | 0.14 | 0.14 | 0.14 | 0.14 | 0.14 |
| | MASS | | | | | | | |
| ALKOXYSILANE COMPOUND | PARTS BY | — | — | — | — | 0.29 | 0.58 | 0.58 |
| | MASS | | | | | | | |
| CYLINDER TEMPERATURE | ° C. | 320 | 320 | 340 | 360 | 320 | 320 | 300 |
| OF KNEADING PORTION | | | | | | | | |
| GATE-SIDE TRANSMITTANCE | % | 29.8 | 32.2 | 32.1 | 31.8 | 32.0 | 35.2 | 35.9 |
| CENTRAL TRANSMITTANCE | % | 30.9 | 35.5 | 35.4 | 34.8 | 34.7 | 36.1 | 36.2 |
| FLOW END-SIDE TRANSMITTANCE | % | 31.6 | 38.0 | 38.1 | 37.0 | 36.8 | 36.2 | 36.3 |
| GATE-SIDE TRANSMITTANCE | | REF. | 1.08 | 1.08 | 1.07 | 1.14 | 1.18 | 1.20 |
| RATIO (T1/T2) | | | | | | | | |
| CENTRAL TRANSMITTANCE | | REF. | 1.15 | 1.14 | 1.13 | 1.21 | 1.17 | 1.17 |
| RATIO (T1/T2) | | | | | | | | |
| FLOW END-SIDE TRANSMITTANCE | | REF. | 1.20 | 1.21 | 1.17 | 1.17 | 1.15 | 1.15 |
| RATIO (T1/T2) | | | | | | | | |

TABLE 4

| | | COMP | | | | | | | |
|---|---|---|---|---|---|---|---|---|---|
| | | EX. | EX. | EX. | EX. | EX. | EX. | EX. | EX. |
| | | 4 | 4-1 | 4-2 | 4-3 | 4-4 | 4-5 | 4-6 | 4-7 |
| PPS-2 | PARTS BY | 100 | 100 | 100 | 100 | 100 | 100 | 100 | 100 |
| | MASS | | | | | | | | |
| GLASS FIBER-2 | PARTS BY | 43 | 43 | 43 | 43 | 44 | 43 | 44 | 43 |
| | MASS | | | | | | | | |
| ZINC HYDROXIDE | PARTS BY | — | 0.14 | 0.14 | 0.14 | 0.15 | 0.29 | 0.44 | 0.14 |
| | MASS | | | | | | | | |
| ALKOXYSILANE COMPOUND | PARTS BY | — | — | 0.58 | 0.87 | 1.16 | 0.87 | 0.87 | 0.87 |
| | MASS | | | | | | | | |
| CYLINDER TEMPERATURE | ° C. | 320 | 320 | 320 | 320 | 320 | 320 | 320 | 300 |
| OF KNEADING PORTION | | | | | | | | | |
| GATE-SIDE TRANSMITTANCE | % | 28.2 | 30.9 | 33.1 | 32.8 | 33.6 | 33.3 | 33.3 | 32.9 |
| CENTRAL TRANSMITTANCE | % | 28.8 | 31.5 | 33.5 | 34.5 | 34.5 | 34.9 | 34.9 | 34.6 |
| FLOW END-SIDE TRANSMITTANCE | % | 31.3 | 33.4 | 35.9 | 36.1 | 34.8 | 36.5 | 36.8 | 36.3 |
| GATE-SIDE TRANSMITTANCE | | REF. | 1.10 | 1.17 | 1.17 | 1.19 | 1.18 | 1.18 | 1.17 |
| RATIO (T1/T2) | | | | | | | | | |
| CENTRAL TRANSMITTANCE | | REF. | 1.10 | 1.16 | 1.20 | 1.20 | 1.21 | 1.21 | 1.20 |
| RATIO (T1/T2) | | | | | | | | | |
| FLOW END-SIDE TRANSMITTANCE | | REF. | 1.07 | 1.15 | 1.15 | 1.11 | 1.17 | 1.17 | 1.16 |
| RATIO (T1/T2) | | | | | | | | | |

TABLE 5

| | | COMP. | COMP. | COMP | COMP | COMP | | | | | |
|---|---|---|---|---|---|---|---|---|---|---|---|
| | | EX. | EX. | EX. | EX. | EX. | EX. | EX. | EX. | EX. | EX. |
| | | 5-1 | 5-2 | 5-3 | 5-4 | 5-5 | 5-1 | 5-2 | 5-3 | 5-4 | 5-5 |
| PPS-2 | PARTS BY | 100 | 100 | 100 | 100 | 100 | 100 | 100 | 100 | 100 | 100 |
| | MASS | | | | | | | | | | |
| GLASS FIBER-3 | PARTS BY | 25 | 67 | — | — | — | 25 | 67 | — | — | — |
| | MASS | | | | | | | | | | |
| GLASS BEADS | PARTS BY | — | — | 5 | 25 | 67 | — | — | 5 | 25 | 67 |
| | MASS | | | | | | | | | | |
| ZINC HYDROXIDE | PARTS BY | — | — | — | — | — | 0.13 | 0.17 | 0.11 | 0.13 | 0.17 |
| | MASS | | | | | | | | | | |
| CYLINDER TEMPERATURE | ° C. | 320 | 320 | 320 | 320 | 320 | 320 | 320 | 320 | 320 | 320 |
| OF KNEADING PORTION | | | | | | | | | | | |
| GATE-SIDE | % | 28.3 | 20.6 | 39.7 | 32.3 | 21.4 | 30.6 | 22.1 | 43.7 | 35.5 | 23.3 |
| TRANSMITTANCE | | | | | | | | | | | |
| CENTRAL | % | 27.1 | 20.1 | 39.3 | 32.2 | 21.6 | 29.6 | 21.5 | 47.1 | 35.4 | 23.5 |
| TRANSMITTANCE | | | | | | | | | | | |
| FLOW END-SIDE | % | 27.9 | 19.4 | 39.3 | 33.0 | 21.8 | 29.5 | 20.0 | 42.1 | 35.3 | 22.9 |
| TRANSMITTANCE | | | | | | | | | | | |
| GATE-SIDE | | REF. 1 | REF. 2 | REF. 3 | REF. 4 | REF. 5 | 1.08 | 1.07 | 1.10 | 1.10 | 1.09 |
| TRANSMITTANCE | | | | | | | | | | | |
| RATIO (T1/T2) | | | | | | | | | | | |
| CENTRAL | | REF. 1 | REF. 2 | REF. 3 | REF. 4 | REF. 5 | 1.09 | 1.07 | 1.20 | 1.10 | 1.09 |
| TRANSMITTANCE | | | | | | | | | | | |
| RATIO (T1/T2) | | | | | | | | | | | |
| FLOW END-SIDE | | REF. 1 | REF. 2 | REF. 3 | REF. 4 | REF. 5 | 1.06 | 1.03 | 1.07 | 1.07 | 1.05 |
| TRANSMITTANCE | | | | | | | | | | | |
| RATIO (T1/T2) | | | | | | | | | | | |

As indicated in Tables 1 to 5, the molded articles composed of the resin compositions of the examples had improved laser beam transmittance at all of the gate side, the center, and the flow end side relative to the molded articles composed of the resin compositions of the comparative examples.

### INDUSTRIAL APPLICABILITY

The polyarylene sulfide resin composition according to the present embodiment is provided with the function of improving the laser beam transmittance regardless of the magnitude of the molecular weight of the polyarylene sulfide resin. For this reason, it is suitable for use as a resin composition for laser welding.

### REFERENCE SIGNS LIST

1 Gate-side test piece
2 Central test piece
3 Flow end-side test piece

1. A resin composition for laser welding, comprising:
100 parts by mass of a polyarylene sulfide resin; and
at least 0.03 parts by mass and at most 1.05 parts by mass of a laser beam transmittance improving agent comprising at least one material selected from the group consisting of potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic.

2. The resin composition according to claim 1, comprising more than 0 and at most 105 parts by mass of an inorganic filler relative to 100 parts by mass of the polyarylene sulfide resin.

3. The resin composition according to claim 2, wherein the inorganic filler comprises a fibrous inorganic filler having a cross-sectional area, perpendicular to a lengthwise direction, of at least 60 μm² and at most 500 μm².

4. The resin composition according to claim 2, wherein the inorganic filler comprises a particulate inorganic filler having an average particle size of at least 10 μm and at most 40 μm.

5. The resin composition according to claim 1, comprising at least 0.1 parts by mass and at most 1.5 parts by mass of an alkoxysilane compound relative to 100 parts by mass of the polyarylene sulfide resin.

6. The resin composition according to claim 1, wherein the polyarylene sulfide resin has a weight-average molecular weight of at least 10,000 and at most 80,000.

7. The resin composition according to claim 1, used to produce a laser beam transmission-side molded body.

8. A laser beam transmission-side molded body comprising the resin composition according to claim 1.

9. A composite molded body comprising a laser beam transmission-side molded body comprising the resin composition according to claim 1, and a laser beam absorption-side molded body.

10. A method for producing a resin composition for laser welding, the method comprising:
melt-kneading 100 parts by mass of a polyarylene sulfide resin with at least 0.03 parts by mass and at most 1.05 parts by mass of a laser beam transmittance improving agent comprising at least one material selected from the group consisting of potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic.

11. The method according to claim 10, wherein the melt-kneading is performed with a cylinder temperature of a kneading portion in an extruder set to be at least 160° C. and at most 370° C.

12. A method for improving laser beam transmittance of a molded body comprising a polyarylene sulfide resin composition, the method comprising:
blending, with respect to 100 parts by mass of the polyarylene sulfide resin, at least 0.03 parts by mass and at most 1.05 parts by mass of at least one material selected from the group consisting of potassium hydroxide, sodium hydroxide, sodium acetate, calcium hydroxide, potassium acetate, lithium hydroxide, lithium acetate, zinc hydroxide, zinc acetate, magnesium hydroxide, zinc oxide, zinc carbonate, and zinc carbonate basic.

13. The method according to claim 12, wherein the polyarylene sulfide resin composition comprises more than 0 and at most 105 parts by mass of an inorganic filler relative to 100 parts by mass of the polyarylene sulfide resin.

14. The method according to claim 13, wherein the inorganic filler comprises a fibrous inorganic filler having a cross-sectional area, perpendicular to a lengthwise direction, of at least 60 μm² and at most 500 μm².

15. The method according to claim 13, wherein the inorganic filler comprises a particulate inorganic filler having an average particle size of at least 10 μm and at most 40 μm.

16. The method according to claim 12, comprising at least 0.1 parts by mass and at most 1.5 parts by mass of an alkoxysilane compound relative to 100 parts by mass of the polyarylene sulfide resin.

17. The method according to claim 12, wherein the weight-average molecular weight of the polyarylene sulfide resin is at least 10,000 and at most 80,000.
